(19) United States
(12) Patent Application Publication
(10) Pub. No.: US 2019/0356405 A1
(43) Pub. Date: Nov. 21, 2019

(54) PRE-CODING METHOD FOR REMOVING INTERFERENCE IN FULL DUPLEX COMMUNICATION, AND BASE STATION AND USER TERMINAL FOR PERFORMING SAME

(71) Applicant: INDUSTRY-ACADEMIC COOPERATION FOUNDATION, YONSEI UNIVERSITY, Seoul (KR)

(72) Inventors: Dong Ku KIM, Seoul (KR); Kwang-Soon KIM, Seoul (KR); Min Ho YANG, Seoul (KR)

(21) Appl. No.: 16/530,177

(22) Filed: Aug. 2, 2019

Related U.S. Application Data
(63) Continuation of application No. PCT/KR2018/001434, filed on Feb. 2, 2018.

(30) Foreign Application Priority Data
Feb. 3, 2017 (KR) 10-2017-0015465
Jan. 11, 2018 (KR) 10-2018-0003911

(51) Int. Cl. H04J 13/12; H04L 5/14; H04L 5/00; H04J 13/18; H04B 7/0456

(52) U.S. Cl. CPC H04J 13/12; H04L 5/14; H04B 7/0478; H04J 13/18; H04L 5/0016

(57) ABSTRACT

A full duplex-type base station for removing signal interference between half duplex-type an uplink terminal and a downlink terminal, includes: a channel estimation unit which estimates channel coefficients between the base station, uplink terminal and downlink terminal; a reception precoding matrix generation unit which generates a reception precoding matrix on the basis of a first code and a channel with the uplink terminal; and a transmission precoding matrix generation unit which generates a transmission precoding matrix on the basis of a second code that is orthogonal to the first code, and a channel with the downlink terminal, wherein the first code is used for generating a transmission signal of the uplink terminal, the second code is used for removing the transmission signal—including the first code—of the uplink terminal, which is received as an interference signal at the time the downlink terminal receives a signal from the base station.

### CROSS-REFERENCE TO RELATED APPLICATIONS

This application is a continuation of pending PCT International Application No. PCT/KR2018/001434, which was filed on Feb. 2, 2018, and which claims priority under 35 U.S.C 119(a) to Korean Patent Application No. 10-2017-0015465 filed with the Korean Intellectual Property Office on Feb. 3, 2017, and Korean Patent Application No. 10-2018-0003911 filed with the Korean Intellectual Property Office on Jan. 11, 2018. The disclosures of the above patent applications are incorporated herein by reference in their entirety.

### BACKGROUND

### 1. Technical Field

The present disclosure relates to a pre-coding method for removing interference in full-duplex communication and a base station and user terminal for performing the method, more particularly to a pre-coding method and a base station and user terminal for the pre-coding method with which to remove interference between half-duplex type uplink terminals and downlink terminals that communicate with a full-duplex type base station.

### 2. Description of the Related Art

With the explosive increase in mobile traffic in recent times, there is a demand for increased wireless transmission capacity in mobile communication networks.

Among various alternatives, the single-channel full-duplex (FD) system is receiving attention as a revolutionary communication system that can greatly improve wireless transmission capacity.

Current wireless communication systems assume a half-duplex (HD) system, in which a node performs either transmission or reception in a particular time-frequency, where uplink transmission and downlink transmission each uses separate wireless resources.

With the full-duplex system, however, a node is able to transmit wireless signals while simultaneously receiving other signals over the same frequency. As the same wireless resources are used for performing both uplink and downlink transmissions, it is possible to improve the transmission capacity of a wireless link to up to twice as much as the capacity associated with the current half-duplex system.

In an existing wireless network, user terminals connected to the same cell use orthogonal wireless resources where different frequencies and time slots are orthogonal, and therefore it can be said that there is no interference between the terminals.

However, with a full-duplex wireless network, in which the user terminals (uplink terminals and downlink terminals) use the half-duplex system, there is the problem that interference may occur between user terminals within a cell.

FIG. 1 is a conceptual diagram illustrating the occurrence of interference between terminals during communication in a typical full-duplex wireless network, where multiple user terminals and a base station (BS) can be included.

As can be seen in FIG. 1, when the base station (BS) communicates with uplink terminals and downlink terminals, a transmission by an uplink terminal and a reception by a downlink terminal may occur over the same frequency, so that the signal transmitted by an uplink terminal can act as interference to the downlink terminal.

If the uplink terminal and the downlink terminal are at a close distance from each other, such interference can have a large impact on the performance of the wireless communication for exchanging wireless data.

As such, there is an urgent need for technology that enables stable wireless communication not only for terminals incurring little interference with one another but also for a broad range of terminals vulnerable to possible interference with one another within a full-duplex wireless communication network and also enables efficient communication between an access point or a base station and a multiple number of terminals in full-duplex wireless communication.

### SUMMARY OF THE INVENTION

An aspect of the invention, conceived to resolve the problems of the related art described above, aims to provide a pre-coding method for removing interference between half-duplex type uplink terminals and downlink terminals that communicate with a full-duplex type base station.

To achieve the objective above, an embodiment of the present disclosure provides a base station of a full-duplex type for removing signal interference between an uplink terminal and a downlink terminal of a half-duplex type, where the base station may include: a channel estimation unit configured to estimate channel coefficients between the base station and uplink terminals and downlink terminals; a reception pre-coding matrix generation unit configured to generate a reception pre-coding matrix based on a first code and a channel to the uplink terminal; and a transmission pre-coding matrix generation unit configured to generate a transmission pre-coding matrix based on a second code and a channel to the downlink terminal, and where the first code may be used in generating a transmission signal of the uplink terminal, and the second code may be used for removing the transmission signal of the uplink terminal including the first code received as an interference signal when the downlink terminal receives a signal from the base station.

The reception pre-coding matrix may be the inverse matrix of a matrix that has the products of the channel coefficients between the base station and the uplink terminals and the first code as elements.

The transmission pre-coding matrix may be the inverse matrix of a matrix that has the products of the channel coefficients between the base station and the downlink terminals and the conjugate complex number of the second code as elements.

The transmission pre-coding matrix may be generated by using the formula shown below:

$$[ \begin{matrix}{h}_{1} {C}_{2}^{*} ( 1 ) & {h}_{1} {C}_{2}^{*} ( 2 ) \\ ⋮ & ⋮ \\ {h}_{{K}_{d} {C}_{2}^{*}} ( 1 ) & {h}_{{K}_{d}} {C}_{2}^{*} ( 2 )\end{matrix} ]$$

where hᵢ is a channel coefficient between the base station and an i-th downlink terminal, C₂(1) and C₂(2) are second codes, and C* is a conjugate complex number of C.

The reception pre-coding matrix may be generated by using the formula shown below:

$${[ \begin{matrix}{f}_{1} {C}_{1} ( 1 ) & … & {f}_{{K}_{u}} {C}_{1} ( 1 ) \\ {f}_{1} {C}_{1} ( 2 ) & … & {f}_{{K}_{u}} {C}_{1} ( 2 )\end{matrix} ]}^{- 1}$$

where fⱼ is a channel coefficient between the base station and a j-th downlink terminal, and C₂(1) and C₂(2) are first codes.

Another aspect of the present disclosure provides a base station of a full-duplex type for removing signal interference between an uplink terminal and a downlink terminal of a half-duplex type, where the base station may include: a code assignment unit configured to assign a first code to the uplink terminal and assign a second code orthogonal to the first code to the downlink terminal; and an orthogonal code provision unit configured to provide an orthogonal code including the first code and the second code to a user terminal operating as the uplink terminal or the downlink terminal during scheduling, and where the uplink terminal may use the first code to generate a transmission signal and transmit the transmission signal, and the downlink terminal may use the second code to remove the transmission signal of the uplink terminal including the first code that is received as an interference signal when receiving a signal from the base station.

The code assignment unit may assign one identical first code to all uplink terminals and may assign one identical second code to all downlink terminals.

The length of the orthogonal code may be determined based on the number of uplink terminals and downlink terminals, and the code assignment unit may assign the first code and the second code according to the numbers of uplink terminals and downlink terminals in the number of orthogonal codes corresponding to the determined length.

In cases where the uplink terminals are divided into multiple groups, the multiple groups may be assigned different first codes, and a second code assigned to the downlink terminal may be orthogonal to all of the first codes assigned to the multiple groups.

The base station may transmit a signal by using sub-carriers of a number corresponding to the length of the first code or the second code.

Another embodiment of the present disclosure provides a pre-coding method for removing signal interference between an uplink terminal and a downlink terminal of a half-duplex type, where the pre-coding method may be performed by a base station of a full-duplex type and may include: (a) estimating channel coefficients between the base station and uplink terminals and downlink terminals; (b) generating a reception pre-coding matrix based on a first code and a channel to the uplink terminal; and (c) generating a transmission pre-coding matrix based on a second code and a channel to the downlink terminal, and where the first code may be used in generating a transmission signal of the uplink terminal, and the second code may be used for removing the transmission signal of the uplink terminal including the first code received as an interference signal when the downlink terminal receives a signal from the base station.

The reception pre-coding matrix may be the inverse matrix of a matrix having the products of the channel coefficients between the base station and uplink terminals and the first code as elements.

The transmission pre-coding matrix may be the inverse matrix of a matrix having products of the channel coefficients between the base station and downlink terminals and the conjugate complex number of the second code as elements.

The transmission pre-coding matrix may be generated by using the formula shown below:

$$[ \begin{matrix}{h}_{1} {C}_{2}^{*} ( 1 ) & {h}_{1} {C}_{2}^{*} ( 2 ) \\ ⋮ & ⋮ \\ {h}_{{K}_{d} {C}_{2}^{*}} ( 1 ) & {h}_{{K}_{d}} {C}_{2}^{*} ( 2 )\end{matrix} ]$$

where hᵢis a channel coefficient between the base station and an i-th downlink terminal, C₂(1) and C₂(2) are second codes, and C* is a conjugate complex number of C.

The reception pre-coding matrix may be generated by using the formula shown below:

$${[ \begin{matrix}{f}_{1} {C}_{1} ( 1 ) & … & {f}_{{K}_{u}} {C}_{1} ( 1 ) \\ {f}_{1} {C}_{1} ( 2 ) & … & {f}_{{K}_{u}} {C}_{1} ( 2 )\end{matrix} ]}^{- 1}$$

where fⱼ is a channel coefficient between the base station and a j-th downlink terminal, and C₂(1) and C₂(2) are first codes.

The base station may transmit a signal by using sub-carriers of a number corresponding to the length of the first code or the second code.

Yet another aspect of the present disclosure provides a user terminal configured to transmit signals by way of half-duplex communication, where the user terminal may include: a signal generation unit configured to generate a signal for transmitting to a full-duplex type base station by applying a first code assigned from among orthogonal codes for removing signal interference; and a signal transmission unit configured to transmit the generated signal in time slots of a number corresponding to a length of the first code or by using sub-carriers of a number corresponding to a length of the first code, with a second code from among the orthogonal codes assigned to a downlink terminal receiving a signal by way of half-duplex communication from the base station and with the first code orthogonal to the second code so as to be used in removing the signal that is transmitted from the downlink terminal to the base station and received as an interference signal, and where the signal transmission unit may transmit the generated signal in the time slots in a time domain and by using the sub-carriers in a frequency domain.

In cases where there are two orthogonal codes, the first code may be identical in all of the user terminals that transmit signals by way of half-duplex communication, and the second may be identical in all downlink terminals.

Still another aspect of the present disclosure provides a user terminal configured to receive signals by way of half-duplex communication, where the user terminal may include: a signal reception unit configured to receive a signal transmitted from a full-duplex type base station and receive an interference signal caused by a half-duplex type user terminal (hereinafter referred to as an ‘uplink terminal’) transmitting a signal to the base station; and an interference signal removal unit configured to remove the interference signal by using a second code orthogonal to a first code included in the interference signal, and where the first code may be an orthogonal code assigned to the uplink terminal for removing interference signals.

According to an embodiment of the present disclosure, interference between uplink terminals and downlink terminals can be efficiently removed in a system that includes a full-duplex type base station and half-duplex type user terminals.

The advantageous effects of the present disclosure are not limited to the effect described above but rather encompass all effects that can be derived from the composition of the present disclosure as set forth in the detailed description of the present disclosure or the scope of claims.

### BRIEF DESCRIPTION OF THE DRAWINGS

FIG. 1 is a conceptual diagram illustrating the occurrence of interference between terminals during communication in a typical full-duplex wireless network.

FIG. 2 illustrates the composition of a system for preventing signal interference between terminals in full-duplex communication according to an embodiment of the present disclosure.

FIG. 3A and FIG. 3B illustrate a pre-coding process at a base station according to an embodiment of the present disclosure.

FIG. 4 is a block diagram illustrating the composition of a base station according to an embodiment of the present disclosure.

FIG. 5 is a block diagram illustrating a pre-coding matrix generation unit according to an embodiment of the present disclosure.

FIG. 6 is a block diagram illustrating the composition of an uplink terminal according to an embodiment of the present disclosure.

FIG. 7 illustrates the generation and transmission of a transmitted signal from an uplink terminal according to an embodiment of the present disclosure.

FIG. 8 is a block diagram illustrating the composition of a downlink terminal according to an embodiment of the present disclosure.

FIG. 9 illustrates the interference removal process at a downlink terminal according to an embodiment of the present disclosure.

FIG. 10 is a flow diagram illustrating the operations of a base station according to an embodiment of the present disclosure.

FIG. 11 is a flow diagram illustrating the operations of an uplink terminal according to an embodiment of the present disclosure.

FIG. 12 is a flow diagram illustrating the operations of a downlink terminal according to an embodiment of the present disclosure.

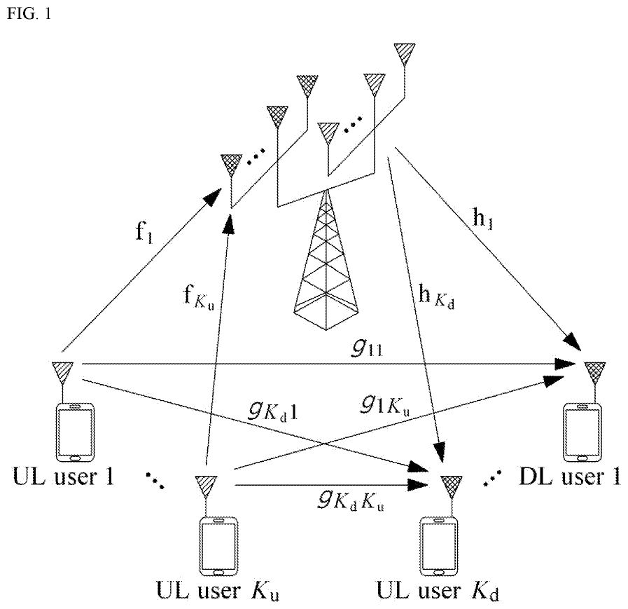

### DETAILED DESCRIPTION OF THE INVENTION

The present disclosure will be described below with reference to the accompanying drawings. However, the present disclosure can be implemented in various different forms and thus is not limited to the embodiments described herein.

For a clearer understanding of the present disclosure, certain parts that are of less relevance to the descriptions have been omitted in the drawings. Throughout the specification, similar reference numerals have been designated to similar elements.

Throughout the specification, reference to a part being “connected” to another part is not limited to meaning “directly connected” but also encompasses “indirectly connected” cases in which there are one or more other members interposed in-between.

Also, when a part is referred to as “including” an element, this does not preclude the presence of other elements, unless specifically stated otherwise, but rather should be interpreted as meaning that one or more other elements can further be included.

Certain embodiments of the present disclosure are described below in more detail, with reference to the accompanying drawings.

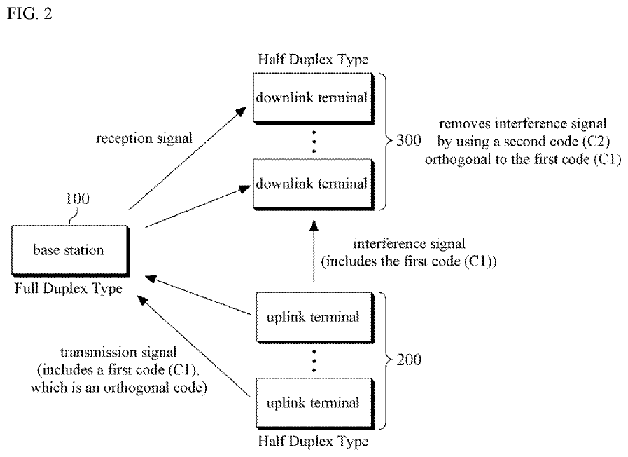

FIG. 2 illustrates the composition of a system for preventing signal interference between terminals in full-duplex communication according to an embodiment of the present disclosure.

The present disclosure, which relates to a system (hereinafter referred to as a ‘full-duplex system’) that includes a multi-user multiple-input multiple-output (MIMO) full-duplex type base station 100 and user terminals 200, 300 which transmit or receive signals via half-duplex communication, is for reducing the interference at a downlink terminal 300 resulting from a signal transmission of an uplink terminal 200 by having the half-duplex type uplink terminal 200 and downlink terminal 300 use different codes (orthogonal codes).

In the following, an OFDM type wireless communication system is described as an example of a full-duplex system but embodiments can be applied in like manner to wireless communication systems that follow different standards.

A base station 100 of a full-duplex system according to an embodiment of the present disclosure can generate orthogonal codes for removing signal interference between an uplink terminal 200 and a downlink terminal 300, assigning a first code from among the orthogonal codes to the uplink terminal 200 and assigning a second code from among the orthogonal codes to the downlink terminal 300.

That is, the first code and the second code may be orthogonal codes that are orthogonal to each other. In the following, these may be referred to separately as the first code and the second code or may be referred to collectively as orthogonal codes.

Also, the base station 100 can transmit the orthogonal codes and assignment information of the first code and second code to the user terminals 200, 300, where these can be transmitted when allocating resources to the user terminals 200, 300, i.e. during scheduling.

The point at which the base station 100 transmits the orthogonal codes again can be when there is a change made to the orthogonal codes (e.g. when the length of the orthogonal codes is changed, etc.).

The uplink terminal 200 can generate a signal by applying (multiplying) the first code, which is the orthogonal code assigned by the base station 100, to the modulated symbol that is to be transmitted, and the generated signal can be transmitted to the base station 100.

Here, the uplink terminal 200 can transmit the generated signal via time slots or sub-carriers of a number corresponding to the length of the first code.

That is, the generated signal can be transmitted to the base station 100 in time slots of a number corresponding to the length of the first code in the time domain and by using sub-carriers of a number corresponding to the length of the first code in the frequency domain.

The following will describe an example in which the generated signal is transmitted to the base station 100 in time slots of a number corresponding to the length of the first code.

For example, if the length of the first code is 2, then the uplink terminal 200 can transmit the signal to the base station 100 in a first time slot and a second time slot.

Whereas in the related art one signal is sent over one time slot, an embodiment of the present disclosure can transmit the signal with the time axis extended according to the length of the orthogonal code, so that the number of users can be increased by as much as the time axis is extended.

The downlink terminal 300 may receive a signal transmitted from the base station 100 as well as an interference signal caused by the uplink terminal 200 transmitting a signal to the base station 100.

Here, as the first code, which is an orthogonal code, is included in the interference signal from the uplink terminal 200, the downlink terminal 300 can remove the interference signal resulting from the uplink terminal 200 by using the second code, which is orthogonal to the first code.

Incidentally, since the uplink terminal 200 transmits the signal in time slots of a number corresponding to the length of the first code, the interference signal from the uplink terminal 200 that is received by the downlink terminal 300 can also be received in time slots of a number corresponding to the length of the first code.

The base station 100 can apply pre-coding matrices to transmission signals and reception signals for beamforming for a MIMO antenna. In the present specification, the pre-coding matrix applied to the transmission signals of the base station is referred to as the transmission pre-coding matrix, and the pre-coding matrix applied to the reception signals is referred to as the reception pre-coding matrix.

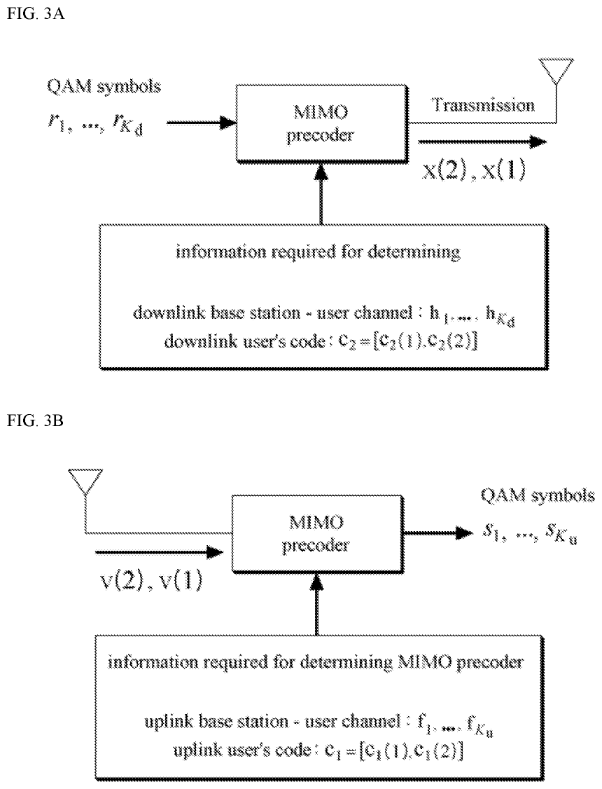

FIGS. 3A and 3B illustrate a pre-coding process at a base station 100 according to an embodiment of the present disclosure.

Referring to FIG. 3A, as the downlink terminal 300 may multiply the second code to the reception signal in order to remove the interference signal caused by the uplink terminal 200, a pre-coding apparatus for the beamforming of the base station antenna according to an embodiment of the present disclosure can determine the transmission pre-coding matrix based on the channels to the downlink terminals 300 and the second code.

Referring to FIG. 3B, as the base station 100 receives a signal including the first code from the uplink terminal 200, the pre-coding apparatus for the beamforming of the base station antenna according to an embodiment of the present disclosure can determine the reception pre-coding matrix based on the channels to the uplink terminals 200 and the first code.

The base station 100 can send the generated signal via time slots or sub-carriers of a number corresponding to the length of the orthogonal codes.

As a base station according to an embodiment of the present disclosure may determine the transmission pre-coding matrix and reception pre-coding matrix by using the channels to the user terminals 200, 300 and the first and second codes in this manner, interference can be removed effectively, and at the same time, the beamforming of the MIMO antenna of the base station can be performed effectively as well.

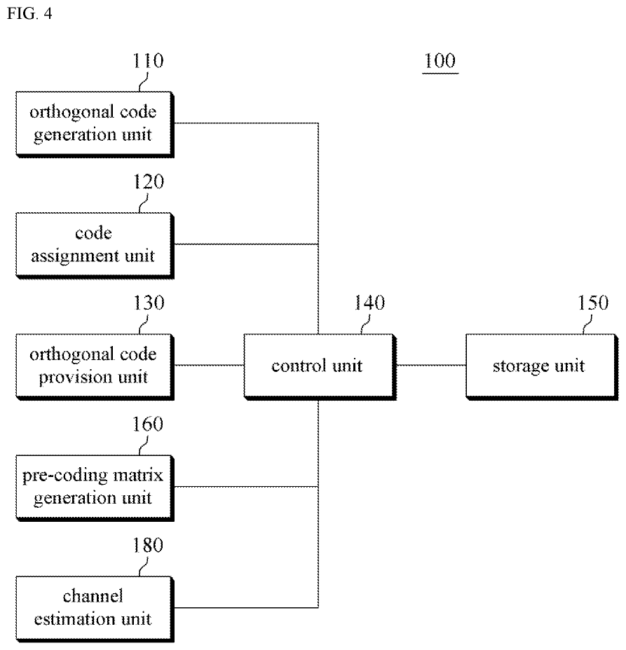

FIG. 4 is a block diagram illustrating the composition of a base station 100 according to an embodiment of the present disclosure.

A base station 100 according to an embodiment of the present disclosure can include an orthogonal code generation unit 110, a code assignment unit 120, an orthogonal code provision unit 130, a pre-coding matrix generation unit 160, a channel estimation unit 180, a control unit 140, and a storage unit 150.

To provide a description of each component, the channel estimation unit 180 can estimate the channel coefficients between the base station and the user terminals 200, 300. A channel coefficient between the base station and an uplink terminal 200 can be used for calculating the reception pre-coding matrix at the reception pre-coding matrix generation unit 164, while a channel coefficient between the base station and a downlink terminal 300 can be used for calculating the transmission pre-coding matrix at the transmission pre-coding matrix generation unit 162.

The orthogonal code generation unit 110 can generate orthogonal codes for removing signal interference between an uplink terminal 200 and a downlink terminal 300. Here, the orthogonal code generation unit 110 can determine the length of the orthogonal codes to reflect the numbers of uplink terminals 200 and downlink terminals 300.

If the length of the orthogonal codes is 2, then the orthogonal codes can include one first code, which may be assigned to uplink terminals 200, and one second code (which is orthogonal to the first code), which may be assigned to downlink terminals 300.

In this case, all of the uplink terminals 200 can use the same first code, while all of the downlink terminals 300 can use the same second code.

The code assignment unit 120 can, from among the orthogonal codes, assign a first code to an uplink terminal 200 and assign a second code that is orthogonal to the first code to a downlink terminal 300. Once a code assignment is performed, the orthogonal codes can be used as assigned, and the code assignment need not be performed at each particular time point.

In one example, for a case in which the length of the orthogonal codes is 2, the code assignment unit 120 can assign one first code and one second code to the uplink terminals 200 and downlink terminals 300, respectively.

In another example, for a case in which the uplink terminals 200 are divided into three groups, A, B, and C, and the length of the orthogonal codes is 4, the code assignment unit 120 can assign three different orthogonal codes as first codes to the groups A, B, and C and assign the remaining one orthogonal code as a second code to the downlink terminals 300.

Thus, in cases where there is asymmetry between the number of uplink terminals 200 and the number of downlink terminals 300, the code assignment unit 120 can make adaptive adjustments according to the number of uplink terminals 200 and the number of downlink terminals 300.

The orthogonal code provision unit 130 can provide the orthogonal codes, including the first codes and second codes, to the user terminals 200, 300, where the time point for providing the orthogonal codes can be when allocating resources, i.e. during scheduling.

Incidentally, information regarding how the first codes and second codes are assigned can also be included when the orthogonal codes are transmitted.

Also, the orthogonal code provision unit 130 can retransmit the orthogonal codes and assignment information to the user terminals 200, 300 when there is a change in the orthogonal codes, such as when the length of the codes are changed, etc.

Here, the orthogonal code provision unit 130 can add the orthogonal codes and assignment information to the field newly added to the front end of the previous subframe for the transmission.

The pre-coding matrix generation unit 160 can generate the pre-coding matrices for the beamforming of the MIMO antenna of the base station.

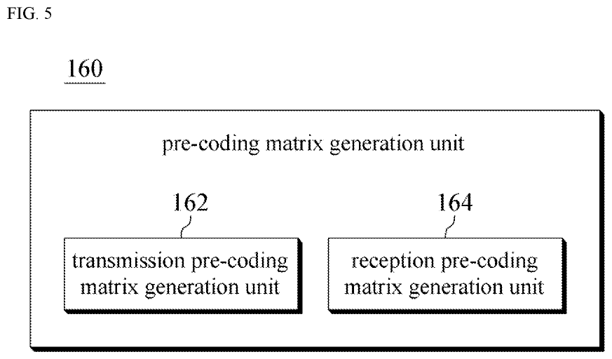

FIG. 5 is a block diagram illustrating a pre-coding matrix generation unit according to an embodiment of the present disclosure.

Referring to FIG. 5, the pre-coding matrix generation unit 160 can include a transmission pre-coding matrix generation unit 162 and a reception pre-coding matrix generation unit 164.

The transmission pre-coding matrix generation unit 162 can generate a transmission pre-coding matrix. The transmission pre-coding matrix can be determined in consideration of the interference removal procedure using orthogonal codes of the downlink terminals 300. That is, the transmission pre-coding matrix can be determined in consideration of the second codes and the channel coefficients between the base station and the downlink terminals 300. A signal with the interference removed using the second code by the i-th downlink terminal 300 may be expressed as Formula 1 shown below.

rᵢ=hᵢ (C₂*(1)x(1)+C₂*(2)x(2)) [Formula 1]

In Formula 1, rᵢ is the signal after the i-th downlink terminal removes interference, hᵢ is the channel coefficient for the base station and the i-th downlink terminal, x(1) and x(2) are transmission signals of the base station, C₂(1) and C₂(2) are second codes, and C* is the conjugate complex number of C.

Thus, the signals after removing the interference of all downlink terminals are as shown below in Formula 2.

[Formula 2]

$$[ \begin{matrix}{h}_{1} {C}_{2}^{*} ( 1 ) & {h}_{1} {C}_{2}^{*} ( 2 ) \\ ⋮ & ⋮ \\ {h}_{{K}_{d}} {c}_{2}^{*} ( 1 ) & {h}_{{K}_{d}} {C}_{2}^{*} ( 2 )\end{matrix} ] [ \begin{matrix}x ( 1 ) \\ x ( 2 )\end{matrix} ] \qquad [ Formula 2 ]$$

In Formula 2, K_{d} is the total number of all downlink terminals 300.

Therefore, the transmission signal of the base station with which the desired signals may be obtained after all of the downlink terminals 300 remove interference may be as expressed in the formula shown below.

[Formula 3]

$$[ \begin{matrix}{x}_{i} ( 1 ) \\ {x}_{i} ( 2 )\end{matrix} ] = {[ {[ \begin{matrix}{h}_{1} {C}_{2}^{*} ( 1 ) & {h}_{1} {C}_{2}^{*} ( 2 ) \\ ⋮ & ⋮ \\ {h}_{{K}_{d}} {c}_{2}^{*} ( 1 ) & {h}_{{K}_{d}} {C}_{2}^{*} ( 2 )\end{matrix} ]}^{- 1} ]}_{i} {r}_{i} , \\ i = 1 , … , {K}_{d} \qquad [ Formula 3 ]$$

In Formula 3, [H⁻¹]ᵢ represents the i-th row vector of H⁻¹, and rᵢ is the signal that is to be obtained after the i-th downlink terminal 300 removes interference.

Therefore, the transmission pre-coding matrix can be determined as in Formula 4 shown below.

$${[ \begin{matrix}{h}_{1} {C}_{2}^{*} ( 1 ) & {h}_{1} {C}_{2}^{*} ( 2 ) \\ ⋮ & ⋮ \\ {h}_{{K}_{d} {C}_{2}^{*}} ( 1 ) & {h}_{{K}_{d}} {C}_{2}^{*} ( 2 )\end{matrix} ]}^{- 1} \qquad [ Formula 4 ]$$

That is, the transmission pre-coding matrix can be calculated as an inverse matrix of a matrix that has the products of the channel coefficients between the base station and the respective downlink terminals 300 and the second codes as its elements.

The reception pre-coding matrix generation unit 164 can generate a reception pre-coding matrix. The reception pre-coding matrix can be determined in consideration of the transmission signals of the uplink terminals 200. That is, the reception pre-coding matrix can be determined in consideration of the first codes and the channel coefficients between the base station and the uplink terminals 200.

The reception signals of the base station received from all uplink terminals 200 are as expressed in Formula 5 shown below.

$$[ \begin{matrix}υ ( 1 ) \\ υ ( 2 )\end{matrix} ] = [ \begin{matrix}{f}_{1} {C}_{1} ( 1 ) & … & {f}_{{K}_{u }} {C}_{1} ( 1 ) \\ {f}_{1} {C}_{1} ( 2 ) & … & {f}_{{K}_{u}} {C}_{1} ( 2 )\end{matrix} ] [ \begin{matrix}{s}_{1} \\ ⋮ \\ {s}_{{K}_{u}}\end{matrix} ] \qquad [ Formula 5 ]$$

In Formula 5, v(1) and v(2) are reception signals of the base station, fⱼ is the channel coefficient between the j-th uplink terminal 200 and the base station, C₁ is the first code, sⱼ is the signal that the j-th uplink terminal 200 wishes to send, and Kᵤ is the total number of all uplink terminals 200.

Therefore, the signal that an uplink terminal 200 wishes to send can be calculated by using Formula 6 shown below.

$${[ \begin{matrix}{f}_{1} {C}_{1} ( 1 ) & … & {f}_{{K}_{u }} {C}_{1} ( 1 ) \\ {f}_{1} {C}_{1} ( 2 ) & … & {f}_{{K}_{u}} {C}_{1} ( 2 )\end{matrix} ]}^{- 1} [ \begin{matrix}υ ( 1 ) \\ υ ( 2 )\end{matrix} ] = [ \begin{matrix}{s}_{1} \\ ⋮ \\ {s}_{{K}_{u}}\end{matrix} ] \qquad [ Formula 6 ]$$

Therefore, the reception pre-coding matrix can be determined as Formula 7 shown below.

$${[ \begin{matrix}{f}_{1} {C}_{1} ( 1 ) & … & {f}_{{K}_{u }} {C}_{1} ( 1 ) \\ {f}_{1} {C}_{1} ( 2 ) & … & {f}_{{K}_{u}} {C}_{1} ( 2 )\end{matrix} ]}^{- 1} \qquad [ Formula 7 ]$$

That is, the reception pre-coding matrix can be calculated as an inverse matrix of a matrix that has products of the channel coefficients between the base station and the respective uplink terminals 200 and the first code as its elements.

The control unit 140 can provide control such that the components of the base station 100, such as the orthogonal code generation unit 110, code assignment unit 120, orthogonal code provision unit 130, pre-coding matrix generation unit 160, and channel estimation unit 180 for example, may perform the operations described above.

The storage unit 150 can store the algorithms by which the control unit 140 controls the components of the base station 100 as well as the various data needed by or derived from the control process.

In another embodiment of the present disclosure, the base station 100 can be composed of only the pre-coding matrix generation unit 160, channel estimation unit 180, control unit 140, and storage unit 150. In another embodiment of the present disclosure, the base station 100 may not include the orthogonal code generation unit 110, code assignment unit 120, and orthogonal code provision unit 130. The orthogonal codes can be configured and stored beforehand.

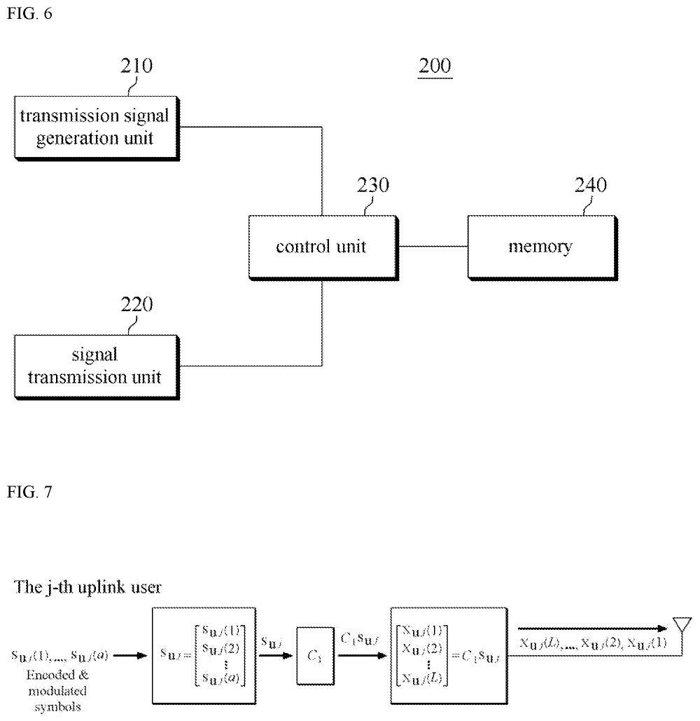

FIG. 6 is a block diagram illustrating the composition of an uplink terminal according to an embodiment of the present disclosure, and FIG. 7 illustrates the generation and transmission of a transmitted signal from an uplink terminal according to an embodiment of the present disclosure.

An uplink terminal 200 according to an embodiment of the present disclosure can include a transmission signal generation unit 210, a signal transmission unit 220, a control unit 230, and a memory 240.

To provide a description of each component, the transmission signal generation unit 210 can generate a signal by using a first code C₁ , which is to allow the downlink terminal 300 to remove interference caused by the transmission signal of the uplink terminal 200.

More specifically, supposing that the transmission signal of the j-th uplink terminal 200 is xᵤⱼ(t) and the modulated symbol containing information which the j-th uplink terminal 200 wishes to transmit to the base station 100 is sᵤⱼ, the transmission signal generated during L symbols by an applying of the first code C₁ by the transmission signal generation unit 210 can be represented as Formula 8 shown below.

$$[ \begin{matrix}{x}_{uj} ( 1 ) \\ {x}_{uj} ( 2 ) \\ ⋮ \\ {x}_{uj} ( L )\end{matrix} ] = {C}_{1} {s}_{uj} \qquad [ Formula 8 ]$$

The process by which the uplink terminal 200 thus generates and transmits a transmission signal is illustrated in FIG. 5.

The signal transmission unit 220 can transmit the transmission signal generated at the transmission signal generation unit 210 to the base station 100.

Here, the signal transmission unit 220 can transmit the generated signal in time slots of a number corresponding to the length of the first code C₁.

For example, if the symbol is 2 (L=2), and the first code is

$$[ \begin{matrix}{x}_{uj} ( 1 ) \\ {x}_{uj} ( 2 ) \\ ⋮ \\ {x}_{uj} ( L )\end{matrix} ] = {C}_{1} {s}_{uj} \qquad [ Formula 8 ]$$

then due to Formula 8 above, the transmission signal can be represented as Formula 9 shown below.

$$[ \begin{matrix}{x}_{uj} ( 1 ) \\ {x}_{uj} ( 2 )\end{matrix} ] = [ \begin{matrix}{c}_{11} \\ {c}_{21}\end{matrix} ] {s}_{uj} , j ∈ [ 1 \text{:} {K}_{u} ] \qquad [ Formula 9 ]$$

Here, Kᵤ is the number of uplink users, while (1) and (2) on the left can represent the sub-carriers or times for transmitting signals.

Thus, c₁₁·sᵤⱼ can be transmitted in a first time slot xᵤⱼ(1), and c₂₁·sᵤⱼ can be transmitted in a second time slot xᵤⱼ(2).

Whereas the related art may entail transmitting one signal in one time slot, an embodiment of the present disclosure can transmit signals with the time axis extended according to the length of the code, so that the number of users can be increased by as much as the time axis is extended.

The control unit 230 can provide control such that the components of the uplink terminal 200, such as the transmission signal generation unit 210 and the signal transmission unit 220 for example, perform the operations described above to enable the uplink terminal 200 to generate a signal using a first code C₁, which is an orthogonal code, and transmit the signal in time slots corresponding to the length of the first code when transmitting the signal to the base station 100. The control unit 230 can also control the memory 240.

The memory 240 can store the algorithms by which the control unit 230 controls the components of the uplink terminal 200 as well as the various data needed by or derived from the control process.

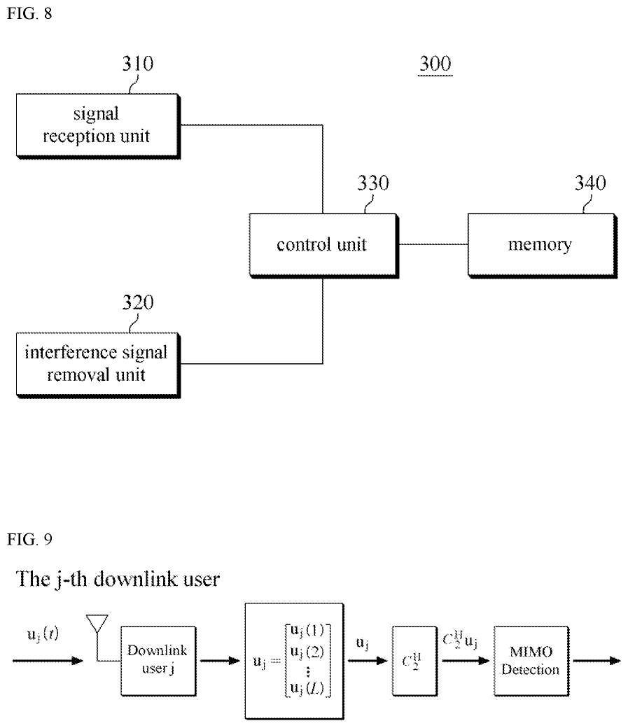

FIG. 8 is a block diagram illustrating the composition of a downlink terminal according to an embodiment of the present disclosure, and FIG. 9 illustrates the interference removal process at a downlink terminal according to an embodiment of the present disclosure.

A downlink terminal 300 according to an embodiment of the present disclosure can include a signal reception unit 310, an interference signal removal unit 320, a control unit 330, and a memory 340.

To provide a description of each component, the signal reception unit 310 can receive a signal from the base station 100, where a part of a signal transmitted by an uplink terminal 200 to the base station 100 can also be received.

This is because, whereas the uplink terminal 200 and the downlink terminal 300 transmit or receive signals via half-duplex communication, the base station 100 operates in full-duplex communication.

The signal received at the signal reception unit 310 can be represented mathematically as Formula 10 shown below.

$${u}_{i} ( t ) = {h}_{i} {W}_{d} ( t ) {\sum }_{j = 1}^{{K}_{d}} {P}_{j} ( t ) {s}_{dj} ( t ) + {\sum }_{j = 1}^{{K}_{u}} {g}_{ji} {x}_{uj} ( t ) + {n}_{i} ( t ) \qquad [ Formula 10 ]$$

Here, u(t) is a signal received by a downlink terminal 300 at time t, h is the channel coefficient between the transmission unit of the base station 100 and the downlink terminal 300, W_{d} is an analog pre-coding matrix of the base station 100 for beamforming, K_{d} is the number of downlink terminals 300, S_{d} is a modulated symbol containing the information that is to transmitted from the base station 100 to the downlink terminal 300, P is a digital pre-coding matrix for the S_{d} of the base station 100 for beamforming, Kᵤ is the number of uplink terminals 200, gⱼᵢ is the channel coefficient between the j-th uplink terminal 200 and the i-th downlink terminal 300, xᵤ is the transmission signal of the uplink terminal 200, and n(t) is the noise of a downlink terminal 300.

The signal received at the signal reception unit 310 of the downlink terminal 300 for L symbols can be represented as Formula 11 shown below.

$$\begin{matrix}{u}_{i} = [ \begin{matrix}{u}_{i} ( 1 ) \\ ⋮ \\ {u}_{i} ( L )\end{matrix} ] \\ = \underbrace{[ \begin{matrix}{h}_{i} {W}_{d} ( 1 ) & … & 0 \\ ⋮ & ⋱ & ⋮ \\ 0 & … & {h}_{i} {W}_{d} ( L )\end{matrix} ]}_{{=}^{Δ} {H}_{d}} \underbrace{[ \begin{matrix}{P}_{1} ( 1 ) & … & {P}_{{K}_{d}} ( 1 ) \\ {P}_{1} ( 2 ) & … & {P}_{{K}_{d}} ( 2 ) \\ ⋮ & ⋮ & ⋮ \\ {P}_{1} ( L ) & … & {P}_{{K}_{d}} ( L )\end{matrix} ]}_{{=}^{Δ} {H}_{d}} [ \begin{matrix}{s}_{d 1} \\ {s}_{d 2} \\ ⋮ \\ {s}_{{dK}_{d}}\end{matrix} ] + \\ {\sum }_{j = 1}^{{K}_{d}} {g}_{ji} [ \begin{matrix}{x}_{uj} ( 1 ) \\ {x}_{uj} ( 2 ) \\ ⋮ \\ {x}_{uj} ( L )\end{matrix} ] + [ \begin{matrix}{n}_{i} ( 1 ) \\ {n}_{i} ( 2 ) \\ ⋮ \\ {n}_{i} ( L )\end{matrix} ] \\ = {H}_{di} P [ \begin{matrix}{s}_{d 1} \\ {s}_{d 2} \\ ⋮ \\ {s}_{{dK}_{d}}\end{matrix} ] + {\sum }_{j = 1}^{{K}_{u}} {g}_{ji} [ \begin{matrix}{x}_{uj} ( 1 ) \\ {x}_{uj} ( 2 ) \\ ⋮ \\ {x}_{uj} ( L )\end{matrix} ] + [ \begin{matrix}{n}_{i} ( 1 ) \\ {n}_{i} ( 2 ) \\ ⋮ \\ {n}_{i} ( L )\end{matrix} ]\end{matrix} \qquad [ Formula 11 ]$$

By applying Formula 8 to Formula 11, the following Formula 12 can be obtained.

$${u}_{i} = [ \begin{matrix}{u}_{i} ( 1 ) \\ ⋮ \\ {u}_{i} ( L )\end{matrix} ] = {H}_{di} P [ \begin{matrix}{s}_{d 1} \\ {s}_{d 2} \\ ⋮ \\ {s}_{{dK}_{d}}\end{matrix} ] + {\sum }_{j = 1}^{{K}_{u}} {g}_{ji} {C}_{1} [ \begin{matrix}{s}_{uj} ( 1 ) \\ {s}_{uj} ( 2 ) \\ ⋮ \\ {s}_{uj} ( a )\end{matrix} ] + [ \begin{matrix}{n}_{i} ( 1 ) \\ {n}_{i} ( 2 ) \\ ⋮ \\ {n}_{i} ( L )\end{matrix} ] \qquad [ Formula 12 ]$$

Here, it can be seen that, from among the signals transmitted by the uplink terminal 200 to the base station 100, the signal received at the downlink terminal 300 has the ‘first code C₁’ incorporated therein.

The interference signal removal unit 320 can remove the interference signal, which is the signal of the uplink terminal 200, from the signal received by the signal reception unit 310, or in other words, remove the signal received at the downlink terminal 300 that is part of the signal transmitted from the uplink terminal 200 to the base station 100.

For this, the interference signal removal unit 320 can use (apply an inner product of) a second code C₂ (also referred to herein as an ‘orthogonal code’), which is a code that is orthogonal to the code C₁ of the uplink terminal 200, to remove the interference signal caused by the uplink terminal 200 that is included in the reception signal. This can be represented mathematically as Formula 13 shown below.

$$\begin{matrix}{C}_{2}^{H} {u}_{i} = {C}_{2}^{H} {H}_{di} P [ \begin{matrix}{s}_{d 1} \\ {s}_{d 2} \\ ⋮ \\ {s}_{{dK}_{d}}\end{matrix} ] + {\sum }_{j = 1}^{{K}_{u}} {g}_{ji} {C}_{2}^{H} {C}_{1} [ \begin{matrix}{s}_{uj} ( 1 ) \\ {s}_{uj} ( 2 ) \\ ⋮ \\ {s}_{uj} ( a )\end{matrix} ] + \\ {C}_{2}^{H} [ \begin{matrix}{n}_{i} ( 1 ) \\ {n}_{i} ( 2 ) \\ ⋮ \\ {n}_{i} ( L )\end{matrix} ] \\ = {C}_{2}^{H} {H}_{di} P [ \begin{matrix}{s}_{d 1} \\ {s}_{d 2} \\ ⋮ \\ {s}_{{dK}_{d}}\end{matrix} ] + {C}_{2}^{H} [ \begin{matrix}{n}_{i} ( 1 ) \\ {n}_{i} ( 2 ) \\ ⋮ \\ {n}_{i} ( L )\end{matrix} ]\end{matrix} \qquad [ Formula 13 ]$$

From Formula 13, it can be ascertained that, as a result of applying the inner product of the orthogonal code C₂ to the interference signal caused by the uplink terminal 200, the corresponding interference signal has been removed.

Incidentally, for the example mentioned when describing the uplink terminal 200, i.e. when the length of the first code C₁ is 2 and

$${C}_{1} = [ \begin{matrix}{c}_{11} \\ {c}_{21}\end{matrix} ] ,$$

the second code C₂ orthogonal to the first code can be represented as

$${C}_{2} = [ \begin{matrix}{c}_{21} \\ {c}_{22}\end{matrix} ] .$$

The procedure by which the downlink terminal 300 thus removes the interference signal caused by the uplink terminal 200 is illustrated in FIG. 9.

The control unit 330 can provide control such that the components of the downlink terminal 300, such as the signal reception unit 310, interference signal removal unit 320, and memory 340 for example, perform the operations described above to enable the downlink terminal 300 to remove the interference signal caused by the uplink terminal 200 by using the orthogonal code C₂.

The memory 340 can store the algorithms by which the control unit 330 controls the components of the downlink terminal 300 as well as the various data needed by or derived from the control process.

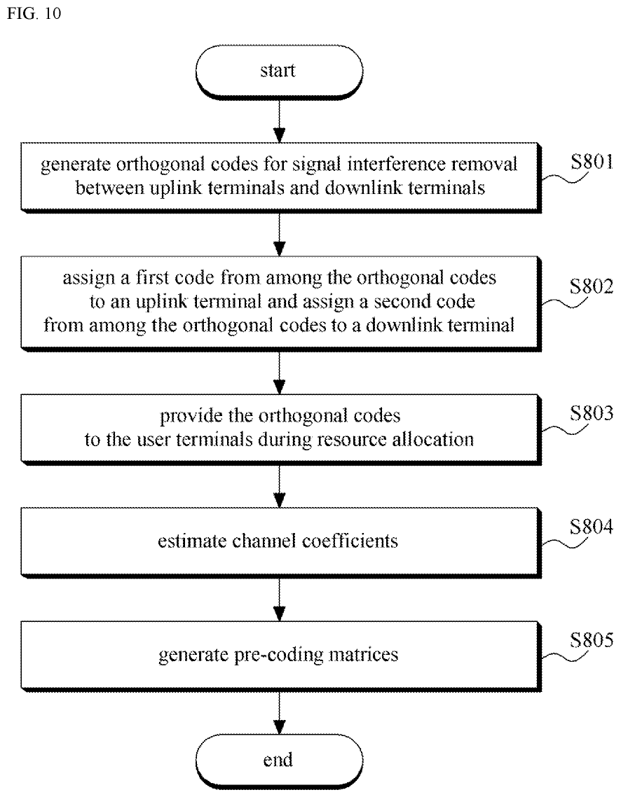

FIG. 10 is a flow diagram illustrating the operations of a base station 100 according to an embodiment of the present disclosure.

The base station 100 may generate orthogonal codes of a particular length that reflects the numbers of uplink terminals 200 and downlink terminals 300 (operation S801).

After operation S801, the base station 100 may assign first codes from among the orthogonal codes to the uplink terminals 200 and may assign second codes from among the orthogonal codes to the downlink terminals 300 (operation S802).

After operation S802, the base station 100 may provide an orthogonal code to a user terminal operating as an uplink terminal or a downlink terminal when allocating resources, i.e. during scheduling (operation S803).

Here, assignment information associated with the assignment of the first codes and second codes can further be included in the provision.

After operation S803, the base station 100 may estimate the channel coefficients to the respective terminals (operation S804).

After operation S804, the base station 100 may generate pre-coding matrices based on the orthogonal codes and the channel coefficients (operation S805).

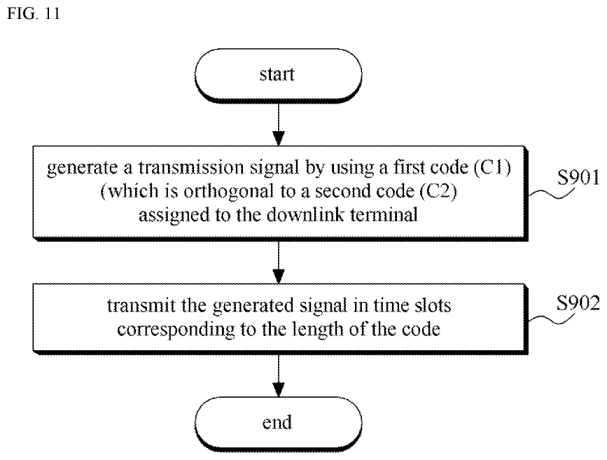

FIG. 11 is a flow diagram illustrating the operations of an uplink terminal according to an embodiment of the present disclosure.

The uplink terminal 200 may generate a signal that is to be transmitted to the base station 100 during L symbols. Here, the signal may be generated by using a first code C₁ which is for enabling the downlink terminal 300 to remove interference resulting from the transmission signal of the uplink terminal 200 (operation S901).

Incidentally, the first code C₁ may be orthogonal code with a second code C₂, which may be an orthogonal code assigned to the downlink terminal 300.

After operation S901, the uplink terminal 200 may transmit the generated signal to the base station 100 in time slots corresponding to the length of the orthogonal code (operation S902).

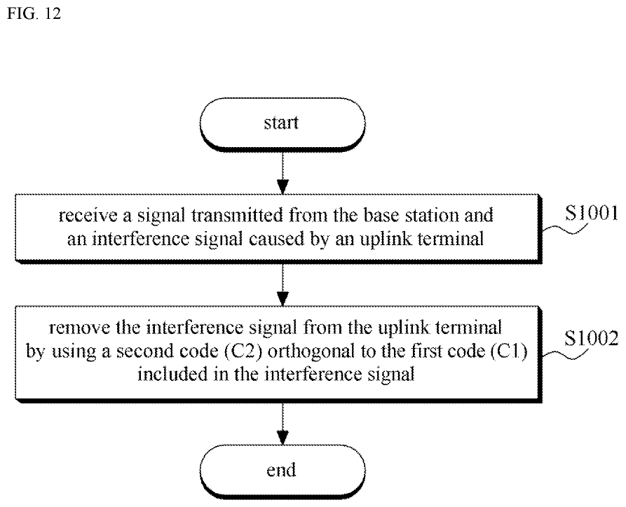

FIG. 12 is a flow diagram illustrating the operations of a downlink terminal according to an embodiment of the present disclosure.

The downlink terminal 300 may receive the signal transmitted from the base station 100 and also an interference signal caused by an uplink terminal 200 transmitting a signal to the base station 100 (operation S1001).

After operation S1001, the downlink terminal 300 may remove the interference signal from the uplink terminal 200 by using a second code C₂ that is an orthogonal code orthogonal to a first code C₁ included in the interference signal (operation S1002).

The technical content described above can be implemented in the form of program instructions that may be performed using various computer means and can be recorded on a computer-readable medium. Such a computer-readable medium can include program instructions, data files, data structures, etc., alone or in combination. The program instructions recorded on the medium can be designed and configured specifically for the disclosure or can be a type of medium known to and used by the skilled person in the field of computer software. Some examples of a computer-readable medium may include magnetic media such as hard disks, floppy disks, magnetic tapes, etc., optical media such as CD-ROM's, DVD's, etc., magneto-optical media such as floptical disks, etc., and hardware devices specially configured to store and execute program instructions such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the disclosure, and vice versa.

The descriptions of the present disclosure provided above are for illustrative purposes only, and the person having ordinary skill in the field of art to which the present disclosure pertains would understand that various specific implementations can be derived without departing from the technical spirit or essential features of the present disclosure.

Thus, the embodiments described above are illustrative in all aspects and do not limit the present disclosure.

In some examples, an element described as a single unit can be practiced in a distributed form, and likewise, elements described as a distributed form can be practiced in an integrated form.

The scope of the present disclosure is defined by the scope of claims set forth below, and all modifications or variations derived from the interpretation and scope of the claims and their equivalent concepts are to be interpreted as being encompassed within the scope of the present disclosure.

What is claimed is:

1. A base station of a full-duplex type for removing signal interference between an uplink terminal and a downlink terminal of a half-duplex type, the base station comprising:
a channel estimation unit configured to estimate channel coefficients between the base station and uplink terminals and downlink terminals;
a reception pre-coding matrix generation unit configured to generate a reception pre-coding matrix based on a first code and a channel to the uplink terminal; and
a transmission pre-coding matrix generation unit configured to generate a transmission pre-coding matrix based on a second code and a channel to the downlink terminal,
wherein the first code is used in generating a transmission signal of the uplink terminal, and
the second code is used for removing the transmission signal of the uplink terminal including the first code received as an interference signal when the downlink terminal receives a signal from the base station.

2. The base station of claim 1, wherein the reception pre-coding matrix is an inverse matrix of a matrix having products of channel coefficients between the base station and uplink terminals and the first code as elements.

3. The base station of claim 1, wherein the transmission pre-coding matrix is an inverse matrix of a matrix having products of channel coefficients between the base station and downlink terminals and a conjugate complex number of the second code as elements.

4. The base station of claim 1, wherein the transmission pre-coding matrix is generated by using a formula shown below:
$$[ \begin{matrix}{h}_{1} {C}_{2}^{*} ( 1 ) & {h}_{1} {C}_{2}^{*} ( 2 ) \\ ⋮ & ⋮ \\ {h}_{{K}_{d}} {c}_{2}^{*} ( 1 ) & {h}_{{K}_{d}} {C}_{2}^{*} ( 2 )\end{matrix} ]$$
where hᵢ is a channel coefficient between the base station and an i-th downlink terminal, C₂(1) and C₂(2) are second codes, and C* is a conjugate complex number of C.

5. The base station of claim 1, wherein the reception pre-coding matrix is generated by using a formula shown below:
$${[ \begin{matrix}{f}_{1} {C}_{1} ( 1 ) & … & {f}_{{K}_{u}} {C}_{1} ( 1 ) \\ {f}_{1} {C}_{1} ( 2 ) & … & {f}_{{K}_{u}} {C}_{1} ( 2 )\end{matrix} ]}^{- 1}$$
where fⱼ is a channel coefficient between the base station and a j-th downlink terminal, and C₂(1) and C₂(2) are first codes.

6. A base station of a full-duplex type for removing signal interference between an uplink terminal and a downlink terminal of a half-duplex type, the base station comprising:
a code assignment unit configured to assign a first code to the uplink terminal and assign a second code orthogonal to the first code to the downlink terminal; and
an orthogonal code provision unit configured to provide an orthogonal code including the first code and the second code to a user terminal operating as the uplink terminal or the downlink terminal during scheduling,
wherein the uplink terminal uses the first code to generate a transmission signal and transmits the transmission signal, and
the downlink terminal uses the second code to remove the transmission signal of the uplink terminal including the first code received as an interference signal when receiving a signal from the base station.

7. The base station of claim 6, wherein the code assignment unit assigns one identical first code to all uplink terminals and assigns one identical second code to all downlink terminals.

8. The base station of claim 6, wherein a length of the orthogonal code is determined based on a number of uplink terminals and downlink terminals, and
the code assignment unit assigns the first code and the second code according to numbers of uplink terminals and downlink terminals in a number of orthogonal codes corresponding to the determined length.

9. The base station of claim 6, wherein the uplink terminals are divided into a plurality of groups, the plurality of groups are assigned different first codes, and
a second code assigned to the downlink terminal is orthogonal to all of the first codes assigned to the plurality of groups.

10. The base station of claim 6, wherein the base station transmits a signal by using sub-carriers of a number corresponding to a length of the first code or the second code.

11. A pre-coding method of removing signal interference between an uplink terminal and a downlink terminal of a half-duplex type, the pre-coding method performed by a base station of a full-duplex type, the pre-coding method comprising:
(a) estimating channel coefficients between the base station and uplink terminals and downlink terminals;
(b) generating a reception pre-coding matrix based on a first code and a channel to the uplink terminal; and
(c) generating a transmission pre-coding matrix based on a second code and a channel to the downlink terminal,
wherein the first code is used in generating a transmission signal of the uplink terminal, and
the second code is used for removing the transmission signal of the uplink terminal including the first code received as an interference signal when the downlink terminal receives a signal from the base station.

12. The pre-coding method of claim 11, wherein the reception pre-coding matrix is an inverse matrix of a matrix having products of the channel coefficients between the base station and uplink terminals and the first code as elements.

13. The pre-coding method of claim 11, wherein the transmission pre-coding matrix is an inverse matrix of a matrix having products of channel coefficients between the base station and downlink terminals and a conjugate complex number of the second code as elements.

14. The pre-coding method of claim 11, wherein the transmission pre-coding matrix is generated by using a formula shown below:
$$[ \begin{matrix}{h}_{1} {C}_{2}^{*} ( 1 ) & {h}_{1} {C}_{2}^{*} ( 2 ) \\ ⋮ & ⋮ \\ {h}_{{K}_{d}} {c}_{2}^{*} ( 1 ) & {h}_{{K}_{d}} {C}_{2}^{*} ( 2 )\end{matrix} ]$$
where hᵢ is a channel coefficient between the base station and an i-th downlink terminal, C₂(1) and C₂(2) are a second code, and C* is a conjugate complex number of C.

15. The pre-coding method of claim 11, wherein the reception pre-coding matrix is generated by using a formula shown below:
$${[ \begin{matrix}{f}_{1} {C}_{1} ( 1 ) & … & {f}_{{K}_{u}} {C}_{1} ( 1 ) \\ {f}_{1} {C}_{1} ( 2 ) & … & {f}_{{K}_{u}} {C}_{1} ( 2 )\end{matrix} ]}^{- 1}$$
where fⱼ is a channel coefficient between the base station and a j-th downlink terminal, and C₂(1) and C₂(2) are a first code.

16. The pre-coding method of claim 11, wherein the base station transmits a signal by using sub-carriers of a number corresponding to a length of the first code or the second code.

17. A user terminal configured to transmit signals by way of half-duplex communication, the user terminal comprising:
a signal generation unit configured to generate a signal for transmitting to a full-duplex type base station by applying a first code assigned from among orthogonal codes for removing signal interference; and
a signal transmission unit configured to transmit the generated signal in time slots of a number corresponding to a length of the first code or by using sub-carriers of a number corresponding to a length of the first code,
wherein a second code from among the orthogonal codes is assigned to a downlink terminal receiving a signal by way of half-duplex communication from the base station, the first code is orthogonal to the second code to be used in removing the signal transmitted from the downlink terminal to the base station and received as an interference signal, and
the signal transmission unit transmits the generated signal in the time slots in a time domain and by using the sub-carriers in a frequency domain.

18. The user terminal of claim 17, wherein the orthogonal codes are two in number,
the first code is identical in all of the user terminals transmitting signals by way of half-duplex communication, and
the second is identical in all downlink terminals.
